(19) United States
(12) Patent Application Publication
(10) Pub. No.: US 2009/0164145 A1
(43) Pub. Date: Jun. 25, 2009

(54) Method and apparatus for spindle stiffness and/or damping in a fluid dynamic bearing spindle motor used in a hard disk drive

(76) Inventors: Ja Choon Koo, Seoul (KR); Myeong-Eop Kim, Sunnyvale, CA (US); Anh Hoang, Santa Clara, CA (US)

Correspondence Address: GREGORY SMITH & ASSOCIATES, 3900 NEWPARK MALL ROAD, 3RD FLOOR, NEWARK, CA, 94560, US

(21) Appl. No.: 12/004,456

(22) Filed: Dec. 19, 2007

(51) Int. Cl. G01L 1/00

(52) U.S. Cl. 702/41; 702/56

(57) ABSTRACT

A test stand is disclosed for estimating the dynamics of a Fluid Dynamic Bearing (FDB) coupling a spindle motor to a rotating hub. The hub includes an air target and displacement plate. At least one air jet strikes the air target, and at least one displacement sensor engages the displacement plate to create a displacement reading. The displacement reading(s) are analyzed to estimate the dynamics of the FDB. The estimates may include but is not limited to the stiffness and/or damping of the FDB.

### TECHNICAL FIELD

This invention relates to testing fluid dynamic bearings in spindle motors for use in a hard disk drive.

### BACKGROUND OF THE INVENTION

Today, a typical hard disk drive includes a spindle motor rotating a spindle, and a hub to which one or more disks are attached, creating rotating disk surfaces upon which information is stored for access by the hard disk drive. For many years, most hard disk drives used ball bearing spindle motors. These motors are becoming obsolete due to imperfections in the roundness of the bearings transmitted through the metal-to-metal interface of the spindle shaft to adversely affect the writing of tracks on the rotating disk surfaces.

A new class of spindle motors known as fluid dynamic bearing motors are likely to replace the ball bearing motors, mainly due to a fundamental improvement in the spindle design using a different kind of bearing between its spindle shaft, and the motor. One side of the bearing couples to the spindle shaft, and the other couples to the motor. The two sides interface through a very thin pool of fluid lubricant, which removes the metal-to-metal interface, consequently minimizing the effect of manufacturing imperfections in either side of the bearing.

While the fluid dynamic bearing spindle motor is better than the ball bearing spindle motor, its use in hard disk drives is not without problems. One problem these motors have relates to how to make efficient, and accurate parts level mechanical performance estimates. Today, the central method of evaluating performance is in an assembly often including several other components of the hard disk drive, often the disk(s), and actuator assembly, itself including the head gimbal assemblies, and voice coil motor. These are very complex assemblies, which make isolating the dynamic response contributed by the fluid dynamic bearing of the spindle motor very difficult, time consuming, and expensive.

Test apparatus, and methods are needed which can provide efficient, accurate performance estimates of fluid dynamic bearings used in spindle motors for hard disk drives.

### SUMMARY OF THE INVENTION

Embodiments of the invention include a test stand used to evaluate the dynamic performance of a Fluid Dynamic Bearing spindle motor includes a spindle motor coupled through a Fluid Dynamic Bearing (FDB) to a spindle shaft and to a hub. The hub includes an air target and a displacement plate. The test stand rigidly configures the spindle motor, at least one air nozzle, and at least one displacement sensor, so that an air jet from the air nozzle can strike the air target and the displacement plate engages the displacement sensor. The spindle motor is stimulated to rotate the hub. The air jet displaces the rotating hub as measured by the displacement sensor interacting with the displacement plate to create a displacement reading. The displacement readings are analyzed to create an estimate of the dynamics of the FDB. This provides a way to test FDB spindle motors inexpensively and accurately.

The air jet may strike the air target at a constant air pressure to create a radial displacement or eccentricity for estimating the stiffness of the FDB, and/or the air jet may strike the air target with a time varying air pressure to create time varying displacements measured by a succession of displacement readings to estimate the mechanical damping of the FDB.

### BRIEF DESCRIPTION OF THE DRAWINGS

FIG. 1 shows in a schematic fashion a test stand embodiment used to evaluate the dynamic performance of a Fluid Dynamic Bearing (FDB) spindle motor. The spindle motor, air nozzle and displacement sensor are shown in one preferred rigid configuration. The test stand includes a base, at least one air nozzle mounted on the base, and at least one displacement sensor also mounted on the base. A FDB spindle motor is mounted on the base, and includes a spindle motor coupled through the FDB to a spindle shaft, and to a disk hub (referred to hereafter as the hub) with an air target, and a displacement plate. The FDB spindle motor aligns with the base so that an air jet from the air nozzle strikes the air target, and the displacement plate engages the displacement sensor. An air source drives the air nozzle to create the air jet displacing the hub as measured by the displacement sensor interacting with the displacement plate. The air source is controlled by a processor, which also stimulates the spindle motor to rotate the hub, and receives at least one reading from the displacement sensor, from which an estimate of the dynamics of the FDB is preferably created;

FIG. 2 shows a refinement of FIG. 1, where the test stand includes more than one air nozzle, preferably with each nozzle separately supplied air pressure to independently control its air jet. Each air source is preferably controlled by the processor, which may include a computer accessibly coupled via a buss to a memory. The computer may be at least partly directed by a program system including program steps residing in the memory. Stimulating the spindle motor may involve a motor controller, and receiving displacement readings may involve an interface;

FIG. 3 shows a flowchart of the program system of FIG. 2 implementing some embodiments of the invention's methods, where the spindle motor is stimulated to rotate the hub with the air target, and the displacement plate. The air jet striking the air target at a constant pressure may be used to create a stiffness estimate of the FDB from at least one displacement reading, and/or the air jet striking the air target as a time varying air pressure may be used to create a damping estimate of the FDB from a succession of displacement readings;

FIG. 4 shows further detail for FIG. 3, where the air jet striking the air target at the constant pressure is analyzed to create a stiffness estimate of the FDB from at least one displacement reading;

FIG. 5 further detail for FIG. 3, where the air jet striking the air target as the time varying air pressure is analyzed with a succession of displacement readings to create a damping estimate of the FDB;

FIG. 6 shows a mechanical side view of another preferred embodiment of an assembly that may be used to rigidly configure the spindle motor, the air nozzle, and the displacement sensor of FIG. 1. This assembly includes a first mount coupling a second mount, with the displacement sensor coupled between them. The second mount couples to a third mount, with the air jet coupled between them. The third mount may be coupled to a top plate, with both preferably cut away to vent the air jet;

FIG. 7 shows a partially assembled view of the test stand with a refinement of the assembly of FIG. 6 supporting the multiple air nozzles of FIG. 2, and the spindle motor mounted on the base, and the displacement sensor does not yet engage the displacement plate; and

FIG. 8 shows the test stand of FIG. 7, now with the top plate in place on the assembly. The displacement sensor engages the displacement plate, and the air nozzles are aligned so that their air jets strike the air target as the hub rotates.

### DETAILED DESCRIPTION

This invention relates to testing Fluid Dynamic Bearing (FDB) spindle motors for use in a hard disk drive, in particular, a test stand for evaluating the dynamic performance of the FDB using at least one air nozzle, and a displacement sensor, and inventive methods to estimate the dynamics of the FDB as well as loading, and unloading FDB spindle motors from the test stand.

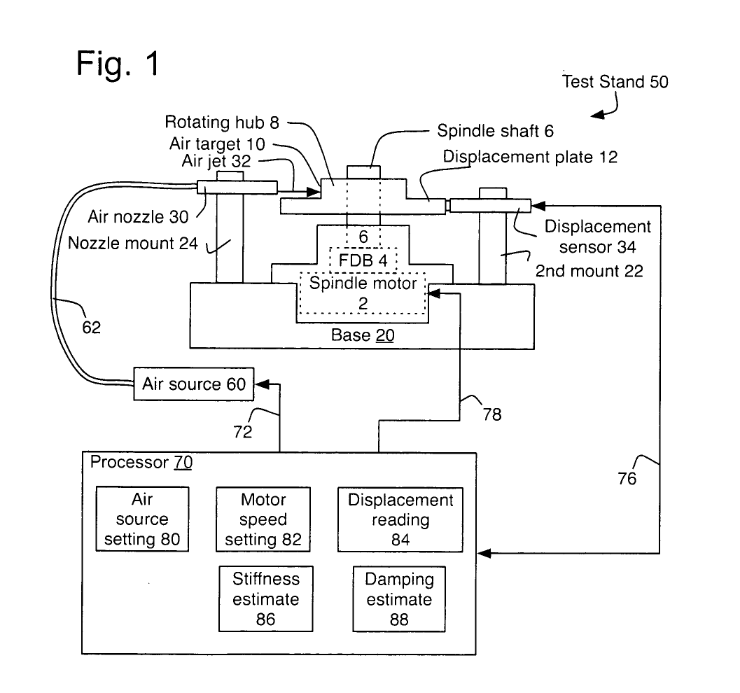

Referring to the drawings more particularly by reference numbers, FIG. 1 shows in a schematic fashion an embodiment of a test stand 50 used to evaluate the dynamic performance of a FDB spindle motor based upon one preferred rigid configuration of the spindle motor, at least one air nozzle and a displacement sensor. The test stand includes a base 20, at least one air nozzle 30 mounted 24 on the base, and at least one displacement sensor 34 also mounted 22 on the base. A FDB spindle motor is mounted on the base, and includes a spindle motor 2 coupled through the Fluid Dynamic Bearing (FDB) 4 to a spindle shaft 6, and to a hub 8 including an air target 10, and a displacement plate 12. The FDB spindle motor aligns with the base so that an air jet 32 from the air nozzle 30 strikes the air target, and the displacement plate engages the displacement sensor.

The displacement sensor 34 is preferably a non-contact sensor. The non-contact sensor may further be a capacitive probe sensor, and/or a laser displacement sensor. In certain situations, the laser displacement sensor may be preferred. In certain embodiments of the invention, in particular during calibration, use of more than one displacement sensor may be preferred. After calibration, certain embodiments may prefer just one displacement sensor.

A processor 70 stimulates 78 the spindle motor 2, rotating the spindle shaft 6, and the hub 8 via the FDB 4. An air source 60 provides the air nozzle 30 with the air jet 32, which strikes the air target 10, and displaces the hub 8 as measured by the displacement sensor 34 interacting with the displacement plate 12. The processor controls 72 the air source, and receives 76 at least one displacement reading 84 from the displacement sensor, from which a stiffness estimate 86, and/or a damping estimate 88 are created.

Providing the air jet 32 is often through an air hose 62 connecting the air source 60 to the air nozzle 30. The air source may include an air compressor, and/or a pressurized air reservoir, and/or a pressure throttle. The processor 70 may direct 72 the air source based upon at least one air source setting 80. These settings may cause the air jet to have an essentially constant air pressure, or one that varies over time. A time varying air pressure setting may cause the air jet to have a periodic air pressure.

The air jet 32 may strike the air target 10 at a constant air pressure that creates a radial displacement or eccentricity as a displacement reading 84. The displacement reading may be analyzed to create a stiffness estimate 86 of the FDB 4. The air source setting 80 may depend upon range of spindle stiffness to be tested.

The air jet 32 may strike the air target 10 with a time varying air pressure to create time varying hub displacements. These displacements of the hub 8 are measured by a succession of displacement readings 84. The readings may be analyzed to estimate the mechanical damping of the FDB 4, known herein as a damping estimate 88.

The displacement readings 84 may preferably be generated with a regular sampling rate. The sampling rate may preferably be approximately 256 samples per second, although many other sampling rates may be usable. In certain embodiments of the invention, the time varying air pressure may further be periodic. A resonant displacement in tune with the period of the air pressure may be used to estimate the mechanical damping of the FDB.

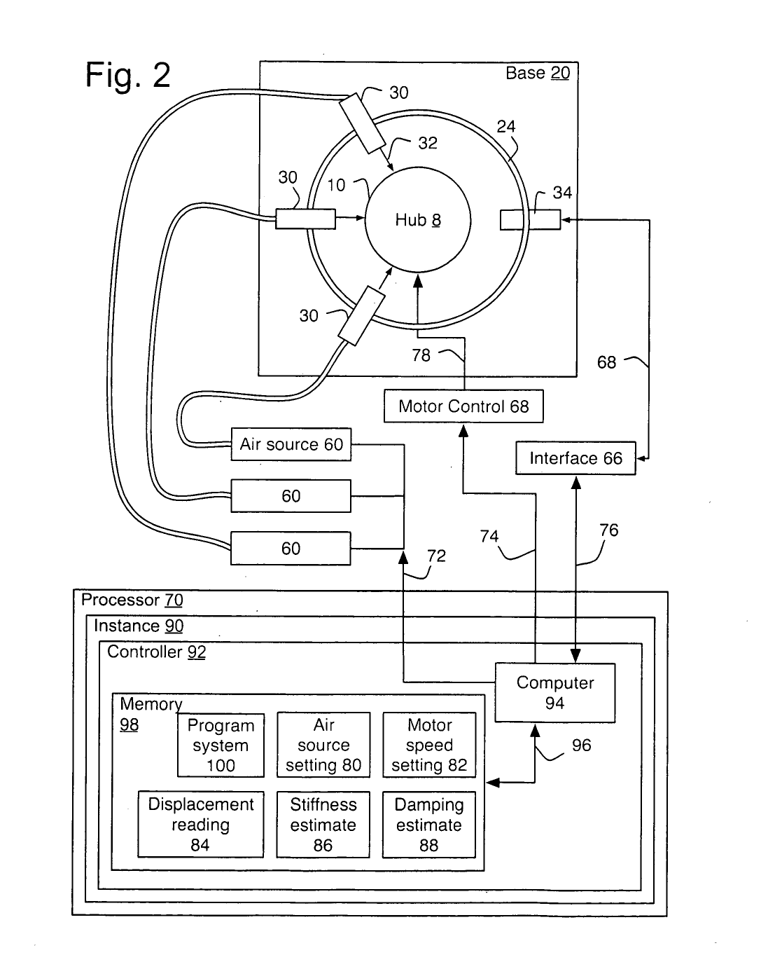

The processor 70 may include at least one instance 90 of a controller 92 as shown in FIG. 2. As used herein, a controller receives at least one input, maintains, and updates at least one state, and generates at least one output based upon at least one of the inputs, and/or at least one of the states. The controller may include a finite state machine, which may be implemented using a programmable logic device such as a field programmable gate array.

FIG. 2 shows a refinement of FIG. 1, where the test stand 50 includes more than one air nozzle 30, preferably with each nozzle separately supplied from a separate air source 60 to independently control its air jet 32. The processor 70 preferably controls each air source. The processor may include a computer 94 accessibly coupled via a buss 96 to a memory 98. The computer may be at least partly directed by a program system 100 including program steps residing in the memory. As used herein, a computer includes at least one data processor, and at least one instruction processor, where each of the data processors is directed by at least one of the instruction processors.

The processor 70 may preferably present 74 a motor speed setting 82 to a motor controller 64 to provide the stimulus 78 to the spindle motor 2, thereby controlling the rotational rate of the hub 8. The motor speed setting may preferably cause the spindle motor to rotate at approximately one of the following rotation rates: 7200 Revolutions Per Minute (RPM), 5400 RPM, 4800 RPM, or 3600 RPM. In other embodiments of the invention, the motor speed setting may cause the spindle motor to rotate at other rotational rates, which may be greater than 7200 RPM. The approximation by the spindle motor of the rotational rate may be within two percent, further within one percent, further within one half percent of the rotational rate. Being within a tolerance of the rotational rate may be calculated by the average root mean square of the variation from the rotational rate over a time interval or may be calculated a statistical measure, such as the standard deviation or variance.

The processor 70 may receive 76 the displacement reading 84 via an interface 66 communicating 68 with the displacement sensor 34, which is engaged with the displacement plate 12 of the hub 8 responding to the air jet 32 striking the air target 10, while the hub 8 is rotated by the spindle motor 2. The displacement sensor may include a stress-strain sensor, which may incorporate one or more piezoelectric devices.

Some of the following figures show flowcharts of at least one embodiment of the method, which may include arrows signifying a flow of control, and sometimes data, supporting various implementations of the method. These include a program operation, or program thread, executing upon the computer 94, and/or a state transition in the finite state machine. The operation of starting a flowchart refers entering a subroutine or a macro instruction sequence in the computer, and/or directing a state transition in the finite state machine, possibly while pushing a return state. The operation of termination in a flowchart refers completion of those operations, which may result in a subroutine return in the computer, and/or popping of a previously stored state in the finite state machine. The operation of terminating a flowchart is denoted by an oval with the word “Exit” in it.

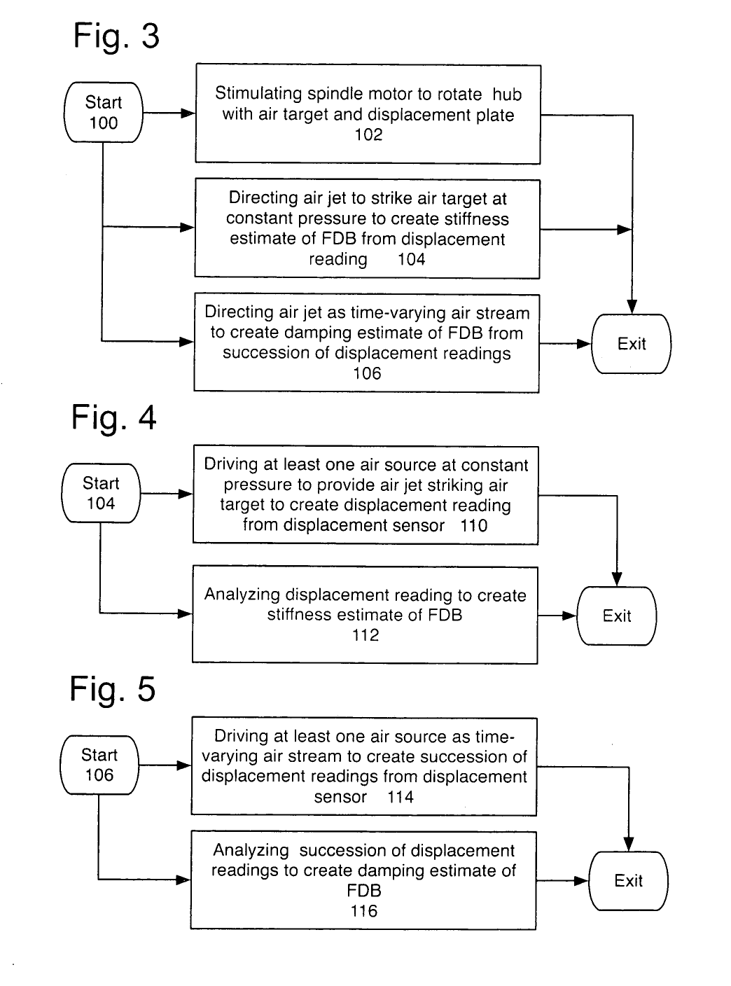

FIG. 3 shows a flowchart of the program system 100 of FIG. 2 implementing some embodiments of the invention's methods where program step 102 stimulates 78 the spindle motor 2 to rotate the hub 8 with the air target 10, and the displacement plate 12. The program system may further include program step 104 directing the air jet 32 to strike the air target at a constant pressure to create a stiffness estimate 86 of the FDB 4 from at least one displacement reading 84, and/or program step 106 directing the air jet to strike the air target as a time varying air pressure to create a damping estimate 88 of the FDB from a succession of displacement readings.

One model that may be preferred assumes that the damping is linear so that the dynamics of the FDB 4 may be approximated by the following equation:

\vec{F}=\vec{F}₀+K\vec{e}+C\vec{e}¹ (1)

Where \vec{F} is the applied force that is air pressure times the effective hub area of the air jet 32 striking the air target 10 of the hub 8. \vec{F₀} is a bias force that is normally zero. K is the static stiffness, and is preferably measured as force over distance, or Newtons per meter, and may preferably be a version of the stiffness estimate 86. \vec{e} is the displacement produced by the air jet striking the air target as measured by the interaction between the displacement plate 12, and the displacement sensor 34, and reported as the displacement reading 84. C is the damping coefficient, and is preferably measured as force over velocity, or Newtons*seconds per meter, and may preferably be a version of the damping estimate 88. \vec{e′} is the rate of change in time calculated from a succession of the displacement readings. \vec{e′} may be seen as the velocity of the hub 8 toward the displacement sensor 34 from the center of the spindle shaft 6.

To estimate the stiffness estimate 86, K, the air pressure may preferably be kept constant, causing the rotating hub 8 to shift, and maintain a particular offset, making \vec{e′}=0.

FIG. 4 shows in further detail program step 104 of FIG. 3: Program step 110 drives the air source 60 to provide the air jet 32 striking the air target 10 at the constant pressure to create the displacement reading 84 from the displacement sensor 34., and program step 112 analyzes the displacement reading to create the stiffness estimate 86 of the FDB 4.

Preferably, once K has been estimated, applying a linearly increasing but sufficiently slowly varying air pressure through the air jets 32 can be used to estimate \vec{e′}. The damping estimate 88, C may be analyzed from the estimate of \vec{e′} using the above equation. The analysis may use a least squares best fit approach. It may be preferred to slowly vary the air pressure so that the above equation is applicable, as K is often found to be a static stiffness.

FIG. 5 shows in further detail program step 106 of FIG. 3: Program step 114 drives at least one air source 60 so that its air jet 32 strikes the air target 10 as the time varying air pressure, creating a succession of displacement readings 84 from the displacement sensor 34., and program step 116 analyzes the succession of displacement readings to create the damping estimate 88 of the FDB 4.

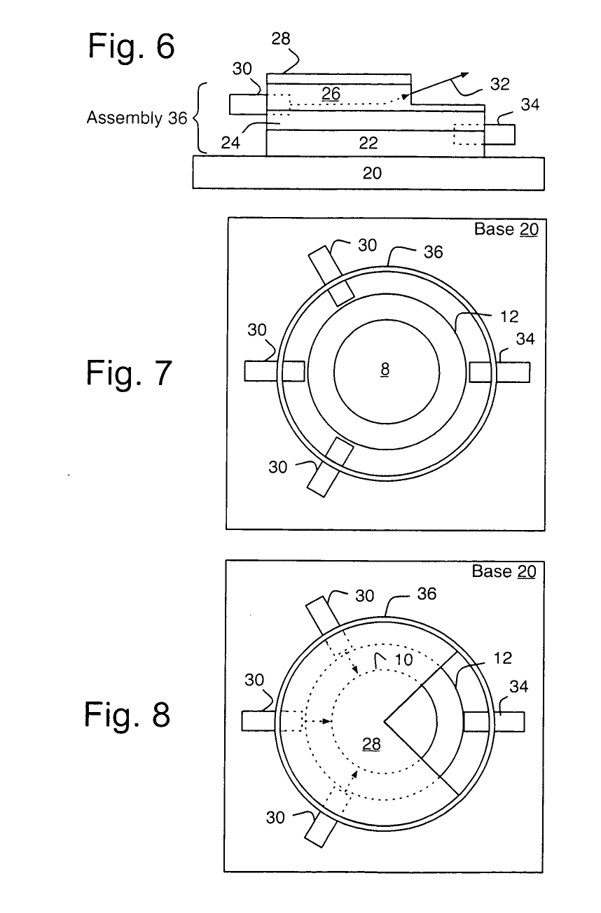

FIG. 6 shows a mechanical side view of one embodiment of an assembly 36 that may be used to rigidly configure the spindle motor with the air nozzle 30, and the displacement sensor 34 of FIG. 1. This assembly includes a first mount 22 coupling a second mount 24, with the displacement sensor coupled between them and the first mount attached to the base 20. The second mount couples to a third mount 26, with the air jet coupled between them. The third mount may further be coupled to a top plate 28, with both cut away to vent the air jet 32.

FIG. 7 shows a partially assembled top view of a refinement of the assembly 36 of FIG. 6 supporting the multiple air nozzles 30 of FIG. 2, and the spindle motor mounted on the base 20 under the hub 8, with the displacement sensor 34 not yet engaged with the displacement plate 22. Note that the first mount 20, second mount 24, and third mount 26 may all be preferably cylindrical as shown from this top view of the assembly.

FIG. 8 shows the assembly 36 of FIG. 7, now with the top plate 28 in place. The displacement sensor 34 engages the displacement plate 12, and the air nozzles 30 are aligned so that their air jets 32 strike the air target 10 as the hub 8 rotates.

Loading the FDB spindle motor onto the test stand 50 may preferably be performed in one of the following ways. The assembly 36 with the air nozzles 30, and displacement sensor 34 may be removed from the base 20. The FDB spindle motor may be mounted so that the spindle motor 2 is secured to the base. The assembly may be attached as shown in FIG. 7, which may serve to align the air nozzles so that their air jets 32 strike the air target 10 of the hub 8. The displacement sensor 34 is engaged with the displacement plate 12 of the hub as shown in FIGS. 1, 2, 7, and 8. In certain embodiments of the invention, the top plate 28 may not be used, whereas in others the assembly may further include the top plate permanently mounted to the third mount 26. In other embodiments, the top plate may be mounted after the displacement sensor has been engaged with the displacement plate.

Unloading the test stand 50 of the tested FDB spindle motor 2 may preferably operate by essentially reversing these steps: the displacement sensor 34 is disengaged from the displacement plate 12. The assembly 36 detached from the base 20., and the FDB spindle motor detached from the base for its removal.

In certain refinements of the invention, ambient conditions, for instance the ambient temperature, atmospheric humidity, and possibly the ambient air pressure about the FDB spindle motor 2 may measured, and/or controlled. The FDB spindle motor, and the relevant components of the test stand 50 may be enclosed in an environmental chamber.

The preceding embodiments provide examples of the invention, and are not meant to constrain the scope of the following claims.

What is claimed is

1. A test stand, comprising:
a fluid dynamic bearing spindle motor, including a spindle motor coupled via a fluid dynamic bearing to a hub including an air target, and a displacement plate; said spindle motor capable of rotating said hub via said fluid dynamic bearing;
at least one air nozzle, each of said at least one air nozzle aligned to deliver an air jet striking said air target;
a displacement sensor configured to engage said displacement plate; and
a processor communicatively coupled to said displacement sensor to receive at least one displacement reading and analyze said at least one displacement reading to create an estimate of the dynamics of said fluid dynamic bearing.

2. The test stand of claim 1, wherein said processor is further configured to direct said air jet to strike said air target at a constant pressure, whereby said estimate of said dynamics includes a stiffness estimate of said fluid dynamic bearing.

3. The test stand of claim 1, wherein said processor is further configured to direct said air jet to strike said air target as a time varying air stream, whereby said estimate of said dynamics includes a damping reading of said fluid dynamic bearing.

4. The test stand of claim 1, wherein said processor comprises at least one instance of at least one controller, wherein each of said controllers receives at least one input, maintains, and updates at least one state, and generates at least one output based upon at least one of the group consisting of said inputs, and said states.

5. The test stand of claim 4, wherein said controller includes a computer accessibly coupled to a memory, and directed by a program system comprising program steps residing in said memory;
wherein said computer comprises at least one data processor, and at least one instruction processor, wherein each of said data processors is at least partly directed by at least one of the instruction processors.

6. The test stand of claim 1, further comprising an assembly to rigidly hold each of said at least one air nozzle and said displacement sensor in a configuration relative to each other and said fluid dynamic bearing spindle motor, said assembly comprising:
a first mount to attach to a base for mounting said spindle motor;
a second mount coupled to said first mount, whereby said displacement sensor is coupled between said first mount and said second mount; and
a third mount coupled to said second mount, whereby each of said at least one air nozzle are coupled between said second mount and said third mount.

7. The test stand of claim 1, further comprising an assembly to rigidly hold said spindle motor, each of said at least one air nozzle and said displacement sensor in a configuration relative to each other, said assembly comprising:
said spindle motor mounted on a base;
said at least one nozzle mounted on said base and configured to deliver said air jet to said air target; and
said displacement sensor mounted on said base and arranged to engage said displacement plate.

8. A method, comprising the steps of:
mounting a spindle motor to a base, said spindle motor being coupled through a fluid dynamic bearing to a hub including an air target and a displacement plate to create a fluid dynamic bearing spindle motor;
mounting an assembly to said base to align at least one air nozzle to strike said air target with an air jet, and to engage said displacement plate to a displacement sensor;
said spindle motor rotating said hub;
directing an air source to drive said air nozzle to strike said air target with said air jet; and
a processor receiving at least one displacement reading from said displacement sensor to create an estimate of said dynamics of said fluid dynamic bearing.

9. The method of claim 8, wherein the step directing said air source, further comprises at least one of the steps of:
said processor directing said air jet to strike said air target at a constant pressure to create a stiffness estimate of said fluid dynamic bearing from at least one of said displacement readings; and
said processor directing said air jet to strike said air target as a time varying air pressure to create a damping estimate of said fluid dynamic bearing from a succession of said displacement readings.

10. The method of claim 8, wherein said assembly includes
a first mount,
a second mounted coupled to said first mount, with a displacement sensor coupled between said first mount and said second mount, and
a third mount coupled to said second mount, with each of said at least one air nozzle are coupled between said second mount, and said third mount.

11. A method for testing a fluid dynamic bearing spindle motor comprising the steps of:
selecting a fluid dynamic bearing spindle motor comprising a spindle motor coupled via a fluid dynamic bearing to a hub including an air target and a displacement plate;
rigidly configuring said spindle motor, each of at least one air nozzle, and said displacement sensor;
said spindle motor rotating said hub with said air target and said displacement plate;
an air jet from said at least one air nozzle striking said air target; and
said processor receiving said at least one displacement reading from said displacement sensor engaging said displacement plate.

12. The method of claim 11, wherein the step rigidly configuring further comprises the steps of:
mounting said spindle motor on a base;
mounting each of said at least one air nozzle on said base; and
mounting said displacement sensor on said base to engage said displacement plate.

13. The method of claim 11, wherein the step rigidly configuring further comprises the steps of:
mounting said spindle motor on a base; and
mounting an assembly to said base to rigidly configure each of said at least one air nozzle and said displacement sensor, said assembly including a first mount coupled to a second mount coupled to a third mount, with said displacement sensor coupled between said first mount and said second mount, and with each of said at least one air nozzle coupled between said second mount and said third mount.

14. The method of claim 11, wherein the step directing said air jet from said air nozzle to strike said air target, further comprises at least one of the steps of:
said processor directing said air jet to strike said air target at a constant pressure to create a stiffness estimate of said fluid dynamic bearing from said displacement reading; and
said processor directing said air jet to strike said air target as a time varying air pressure to create a damping estimate of said fluid dynamic bearing from a succession of said displacement readings.

15. The method of claim 11, further comprising the step analyzing said at least one displacement reading to estimate the dynamics of said fluid dynamic bearing.
